(19) United States
(12) Patent Application Publication
(10) Pub. No.: US 2008/0060550 A1
(43) Pub. Date: Mar. 13, 2008

(54) Color changing skin sealant with co-acid trigger

(76) Inventors: Gavin MacDonald, Decatur, GA (US); Molly K. Smith, Atlanta, GA (US); Kelly Arehart, Roswell, GA (US); Illona Furman Weart, Woodstock, GA (US); Phill Schorr, Atlanta, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/642,359

(22) Filed: Dec. 19, 2006

Related U.S. Application Data
(60) Provisional application No. 60/843,935, filed on Sep. 12, 2006.

(51) Int. Cl. A61Q 19/00

(52) U.S. Cl. 106/162.1; 106/287.1; 106/287.13; 106/287.2; 106/287.25; 106/287.35

(57) ABSTRACT

Skin sealants are applied over skin preps to seal the skin and hold any remaining bacteria in place prior to incisions. It is desirable for the person applying the sealant to know where the sealant has been applied. It is also desirable to be able so see through the sealant to observe the skin to detect any possible infection. A skin sealant is provided that has a pH indicator and co-additive acid that react soon after mixing, rendering the skin prep colorless.

Pursuant to 35 U.S.C. § 120 and/or 35 U.S.C. 119(e), Applicants hereby claim priority from presently copending U.S. Provisional Application No. 60/843,935 filed on Sep. 12, 2006. The entirety of application Ser. No. 60/843,935 is hereby incorporated by reference.

### BACKGROUND OF THE INVENTION

Surgical site infections (SSI) occur following about 2-3 percent of surgeries in the United States with an estimated 500,000 incidents of SSI occurring annually, which can lead to significant patient morbidity and mortality. In addition to the negative impact of such infections on patient health, these potentially avoidable infections contribute significantly to the financial burden experienced by the health care system. SSIs result when an incision becomes contaminated by bacteria, and for most surgeries the primary source of these infection-causing microorganisms is the skin (an exception being surgeries in which the gastrointestinal tract is penetrated).

Various compositions are used to prepare the skin prior to surgery. Skin preparations or “preps” are used to remove some level of microbial load on the skin prior to making an incision. Skin sealant materials are used to protect patients from bacterial infections associated with surgical site incisions and insertion of intravenous needles. Skin preps are applied to the skin and allowed to dry to maximize effectiveness for reducing microorganisms. After the skin prep has dried, the sealant may be applied directly to the skin in liquid form. The sealant forms a coherent film with strong adhesion to the skin through various techniques based on the chemistry of the sealant composition.

Skin preps currently are predominantly povidone-iodine or chlorhexidine gluconate based formulations and may contain alcohol for fast drying and more effective killing of organisms. Time constraints in the operating room and the lack of an indicator that the prep has dried often result in the skin remaining wet when draping and/or surgery begin, creating the possibility of infection. The lack of an indicator can also negatively impact infection since the users cannot know with certainty where the prep and sealant have been applied.

Skin sealants now use a polymer composition that dries to form a film through evaporation of a solvent, for example. Other skin sealants contain monomeric units that polymerize in situ to from a polymeric film. Cyanoacrylate sealants containing 2-cyanoacrylate monomer are an example of the latter type wherein the monomer polymerizes in the presence of a polar species such as water or protein molecules to form an acrylic film. The resulting film formed serves to immobilize bacterial flora found on the skin and prevents their migration into an incision made during a surgical procedure or skin puncture associated with insertion of an intravenous needle.

In some cases, a skin sealant may also encompass substances designed to protect or treat the nails or mucosal surfaces of the body. Such substances include nail polish, eyedrops, nasal sprays, etc and serve to provide an additional barrier between the skin and the environment.

Skin sealants may contain additives such as plasticizing agents to improve film flexibility and conformance, viscosity modifiers to aid in application of the liquid composition, free radical and anionic scavengers to stabilize the product prior to use, biocidal agents to kill immobilized bacteria under the film, and the like.

Skin sealants have also been formulated with colorants to help the user apply the liquid composition uniformly to the skin, especially when large areas are to be covered. There are several problems, however, with existing colorants; addition of a colorant directly to the liquid skin sealant composition can negatively impact both in situ polymerization rates and the conversion reaction, in the case of cyanoacrylate compositions, or evaporation rates and the coalescence process in the case of polymer solution compositions. In addition, known colorants do not provide a visual cue to indicate curing of the composition has been completed. Lastly, after completion of the surgical procedure, the colorant in the sealant can obscure the wound site, making it difficult to detect redness associated with surgical site infections, bruising or leakage.

It is clear that there exists a need for a colorant that provides a visual cue to indicate coverage area and/or curing and that does not obscure the wound site.

### SUMMARY OF THE INVENTION

In response to the foregoing difficulties encountered by those of skill in the art, we have discovered that skin sealants including various pH indicators and co-additive acid triggers may be used to indicate that a skin prep and sealant has been applied. The triggerable pH indicators and co-additive acid triggers may be added either directly to the skin sealant, incorporated into a sponge on the applicator through which the sealant is dispensed and applied to the skin, applied separately or applied simultaneously from a separate reservoir. The amount of pH indicator in the sealant can be adjusted to provide a visual cue to the user of the application area, thickness of the coating and the extent of cure. When the curable composition is applied to the skin it has a first color and changes to a second color in a short period of time thus providing a mutable color changing composition.

### DETAILED DESCRIPTION OF THE INVENTION

Skin preparations or “preps” are used to remove some level of microbial load on the skin prior to making an incision. Skin preps are applied to the skin and allowed to dry to maximize effectiveness for reducing microorganisms. Skin preps currently are predominantly povidone-iodine or chlorhexidine gluconate based formulations and may contain alcohol for fast drying and more effective killing of organisms. Povidone iodine, available commercially as Betadine® is estimated to be used in 80 percent of surgeries as a skin preparation. Betadine® skin prep is an aqueous solution of 10 percent povidone iodine having 1 percent titratable iodine content. When Betadine® skin prep is applied to the skin, it imparts and orange-brown color.

Skin sealant materials are curable coatings used to protect patients from bacterial infections associated with surgical site incisions and insertion of intravenous needles. Skin sealants are often applied directly over or on top of (Betadine®) skin preps. The sealant forms a coherent film with strong adhesion to the skin through various techniques based on the chemistry of the sealant composition.

The term “skin” as used herein, means all external surface areas of the body including nails, hair, skin, eyes, mucosal membranes. The skin proper consists of three layers: epidermis, dermis and subcutaneous tissue.

It would be useful for medical personnel to know exactly where the skin sealant and prep were applied so that they could be sure that the appropriate area was covered. The inventors believe that providing a skin sealant that will change the color of the skin prep over which it is applied will provide valuable information for the medical professional.

One common type of skin sealant is based on cyanoacrylate. When cyanoacrylate-based skin sealants cure, the pH of the coating undergoes an increase in pH from approximately pH 2 to around pH 4. This is due to the curing reaction that absorbs acid (hydrogen ions or hydronium ions) to form the polymer chains. There are reports in the literature of the addition of standard, stand-alone pH indicators whose color transition is in the pH 24 range. Examples of these indicators are pentamethoxy red, crystal violet, methyl green, thymol blue and reported in the literature (example references include http://chemistry.com/library/weekly/aa112201 a.htm or “The Sigma-Aldrich book of stains, dyes and indicators” by F. J. Green published by Aldrich Chemical Company, Milwuakee Wis.). These classic indicators, however, are not considered safe or approved for use on the skin as is the requirement of skin sealants.

The skin contact approved dyes and colorants used herein have not been previously used or reported as pH indicators. These triggerable dyes and colorants do not change color when added alone to the skin sealant and allowed to cure. They have been discovered and demonstrated by the inventors to undergo a vivid color change when triggered by co-additive acids such as citric acid and ascorbic acid. Furthermore, these triggerable dyes and colorants can be used in virtually any skin coating formulation, whether the curing of the base resin produces a pH change or not, because of the addition of the acid trigger. This aspect increases the flexibility and usefulness of the invention considerably as it is not limited to use in cyanoacrylate systems but could include, for example, polysaccharide-based, polyether, polyvinylalcohol, silicone (linear, branched or cyclic), polydimethylsiloxane-polyether, vinylic, gelatin-based, and polyoxirane-based systems.

A number of materials can change color upon a change in pH of one unit. These materials (pH indicators) include metal tannate salts and a series of organic dyes. When a metal salt, such as iron chloride, is mixed with tannic acid the resultant reaction produces a deep violet blue colorant. This colorant was found to be easily dispersed into 2-cyanoacrylate skin sealant to give a deep blue liquid. When ascorbic acid or citric acid was added to the liquid the color was discharged to give a very pale yellow color.

A series of organic dyes that are typically not known or regarded as acid triggerable dyes was identified. These dyes include Rose Bengal, 1-amino-4-hydroxyanthraquinone, Disperse Blue 3 (textile dye known for its good light stability and durability to laundering), 1,4-diaminoanthraquinone and carotene (trans-β-carotene, Food Orange 5).

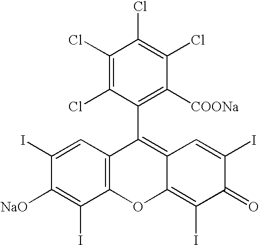

### Rose Bengal a Member of the Anionic Xanthene Dye Class

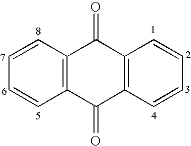

### Anthraquinone Dyes Class

Examples of this class that work in this invention include: 1-amino-4-hydroxyanthraquinone (1=NH₂, 4=OH), 1,4-diaminoanthraquinone (1=NH₂, 4=NH₂) and Dispersed Blue 3 (1=NHCH₃, 4=NHCH₂CH₂OH).

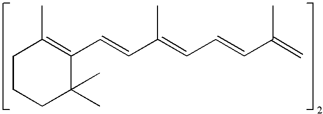

### Trans-β-Carotene Being a Member of the Carotenoid Class of Dyes

The amount (concentration) of the dyes required in the skin sealant was typically between 10 ppm and 1000 ppm, more particularly between 50 ppm and 800 ppm and most particularly between 100 ppm and 500 ppm.

The dyes classes found to be most useful in this invention include quinones, carotenoids, metal salts of tannic acid, and anionic xanthenes.

Triggering acids that can be used in this invention include citric, ascorbic, malic, acetic, propanoic, malonic, cysteine and derivatives of these. The concentration of these acids in the invention can be between 0.001% and 10%, more particularly between 0.01% and 5% and most particularly between 0.1% and 3% all by weight based on the skin sealant.

Skin sealants such as cyanoacrylate sealants containing alkyl cyanoacrylate monomer are an example of the type wherein the monomer polymerizes in the presence of a polar species such as water or protein molecules to form an acrylic film. Cyanoacrylates include, for example, a 2-alkyl cyanoacrylate where the alkyl group is a C₁ to C₈ hydrocarbon which is straight chain, branched chain, or cyclic.

The 2-cyanoacrylate sealant also contain plasticizers such as tri-butyl o-acetyl citrate to provide a more flexible coating and reduce the brittle nature of the cure cyanoacrylate. The plasticizer also help solubilize the dye or colorant into the cyanoacrylate. Typically 20% wt/wt tri-butyl o-acetyl citrate is used in the skin sealant in this study up to 30% wt/wt was used to ensure complete solubility of some of the colorants used in this invention.

There are a number of different ways to prepare the curable coating described herein. The base sealant resin must be maintained in an air-tight container or it will cure. The pH indicator and dye do not have this requirement. The sealant may therefore be placed in a glass vial that may be sealed to exclude air. Either the pH indicator or the acid may be included with the sealant and the other ingredient mixed with the two ingredients in the vial before application to the skin.

Skin sealants are conventionally placed in dispensers having applicator housings until they are needed. One exemplary dispenser has he liquid sealant held in at least one oblong glass ampoule within a rigid nylon housing. The housing has a body and a cap that are slidably connected and it is the cap which holds the ampoule(s). In use, the two parts are moved toward each other to dispense the liquid; the cap moving into the body. Moving the parts together results in breakage of the glass ampoule(s) and dispensing of the liquid. A detent-type locking mechanism holds the body and cap together once they are moved. The locking mechanism consists of slots formed in the cap into which fits a slight protuberance or knoll of plastic formed on the inside surface of the body. Once the ampoule is broken, the liquid travels through a small piece of foam which catches any glass shards that may have been formed by the breakage of the ampoule and thence on to the tip portion of the body. The tip has a number of small holes in it to allow the liquid to pass through. The body tip has a piece of foam on the outside, held in place with a rigid plastic oval-shaped ring that snaps in place on the tip. The outer foam contacts the skin of the patient when the liquid is dispensed. Other types of dispensers may be found in U.S. Pat. Nos. 4,854,760, 4,925,327 and 5,288,159, incorporated herein by reference.

In another embodiment the skin sealant/acid mix and pH indicator may be applied separately to the area containing a skin prep. U.S. Pat. No. 5,928,611 describes a dispenser having a skin sealant reservoir and an active ingredient such as a cross linking accelerator or initiator disposed on a foam piece through which the sealant must pass. One could envision the use of such a dispenser having the pH indicator disposed on the foam piece and the sealant/acid mix passing though it as it is about to be deposited onto the skin. See also U.S. Pat. No. 6,322,852. The location of the acid and pH indicator may of course be reversed as discussed above.

In yet another embodiment, U.S. Pat. No. 6,340,097 describes a dispenser having at least one crushable ampoule within the body of the dispenser which could hold more than one. This would permit one ampoule to hold a skin sealant/acid mix and a second to hold the pH indicator. When the dispenser was used, it would break both ampoules and the sealant/acid mix and pH indicator would mix just before application to the skin. The location of the acid and pH indicator may of course be reversed as discussed above.

In addition to being used as a traditional skin sealant, i.e. as a film forming barrier through which a surgical incision is made, the pH indicator, acid and skin sealant composition may also be used like a to close and/or cover wounds, bruises, abrasions, burns, acne, blisters, bites, stings, punctures, cuts and other disruptions in the skin to protect them from subsequent contamination. The use of the skin sealant composition would therefore not be limited to medical personnel and would not require the use of a skin prep before the skin sealant is applied.

Wound protection is critical in permitting the healing process to take place. Traditional adhesive bandages and gauze wound dressings have been used by the consumer to treat/dress acute wounds or skin irritations. Such adhesive bandages are generally passive, in that they offer little or no chemical treatment for wound healing. Rather, they primarily serve to exert low levels of pressure on the wound, protect the wound from exposure to the environment, and absorb any exudates, which are produced from the wound site. Such bandages generally include a base layer, which is the layer seen by the consumer following application of the bandage to the wound. Such a layer is typically formed from a polymeric material such as a film, nonwoven web, or combination thereof, and may be perforated in some fashion to allow for flexibility and/or further breathability. This layer often includes a film component, having a top side surface which is seen by the consumer after application of the bandage to the wound site, and a bottom side surface (skin contacting surface). A skin-friendly adhesive is usually placed over the base layer bottom side surface to provide a means for attaching the bandage to the consumer. Alternatively, a separate adhesive tape is used to attach the bandage/wound dressing to the wound site, if the bandage/wound dressing is of the non-adhesive type. In the center of the base layer bottom side surface is traditionally positioned an absorbent pad for absorbing exudates from the wound. Finally, a non-stick perforated film layer is normally positioned over the absorbent pad layer, to provide a barrier between the absorbent pad and the wound itself. This allows the wound fluid to move through the perforated layer without sticking to the wound site. Typically the absorbent pad in such bandage does not include any medicinal components, although comparatively recently, bandage manufacturers have started including antibiotic agents on or within bandages to encourage wound healing.

The skin sealant composition of this invention can replace this seemingly complicated bandage construction with a single liquid treatment that will dry to a flexible coating that protects a wound much like a bandage would. Additionally, medicaments such as antibiotic agents may be blended in effective amounts with the composition to provide additional benefits in the area of microbial inhibition and the promotion of wound healing. The sealant may be applied to provide an effectively thick coating over the surface of the superficial wound, burn or abrasion. Because the to-be-treated wound is superficial and does not extend beyond the dermal layer, any polymeric residues diffusing into or forming in the wound will be naturally extruded from the skin. Generally, the sealant provides an adhesive film coating over the wound area which when set is satisfactorily flexible and adherent to the tissue without premature peeling or cracking. The coating generally has a thickness of less than about 0.5 millimeter (mm).

Sealant coatings of such thicknesses form a physical barrier layer over superficial wounds which provide protection for the wound in the same manner as a conventional bandage. Specifically, the coating provides an airtight, waterproof seal around the wound which does not need to be replaced when the wound gets wet. Once applied, the coating prevents bacterial and contaminant entry into the wound, thus reducing the rate of secondary infection. Generally, the adhesive coating does not limit dexterity and promotes faster wound healing. Additionally, unlike conventional bandages, the sealant naturally sloughs off the skin within 2-3 days after application and, accordingly, avoids the discomfort associated with removal of conventional bandages from the skin. However, if early removal of this polymeric coating is desired, such can be achieved by use of solvents such as acetone. Further discussion of this use may be found in U.S. Pat. No. 6,342,213.

By way of elaboration it should be noted that several wound care products are currently being marketed which contain an antiseptic benzalkonium chloride and an antibiotic mixture of polymixin B-sulfate and bacitracin-zinc. Patents in this area of technology have described the use of commonly known antiseptics and antibiotics, such as those described in U.S. Pat. Nos. 4,192,299, 4,147,775, 3,419,006, 3,328,259, and 2,510,993. U.S. Pat. No. 6,054,523, to Braun et al., describes materials that are formed from organopolysiloxanes containing groups that are capable of condensation, a condensation catalyst, an organopolysiloxane resin, a compound containing a basic nitrogen, and polyvinyl alcohol. U.S. Pat. No. 5,112,919, reported a moisture-crosslinkable polymer that was produced by blending a thermoplastic base polymer, such as polyethylene, or a copolymer of ethylene, with 1-butene, 1-hexene, 1-octene, or the like; a solid carrier polymer, such as ethylene vinylacetate copolymer (EVA), containing a silane, such as vinyltrimethoxysilane; and a free-radical generator, such as an organic peroxide; and heating the mixture. The copolymers could then be cross-linked by reaction in the presence of water and a catalyst, such as dibutyltin dilaurate, or stannous octoate. U.S. Pat. No. 4,593,071 to Keough reported moisture cross-linkable ethylene copolymers having pendant silane acryloxy groups.

A polyurethane wound coating is described by Tedeshchl et al., in EP 0992 252 A2, where a lubricious, drug-accommodating coating is described that is the product of a polyisocyanate; an amine donor, and/or a hydroxyl donor; and an isocyanatosilane adduct having terminal isocyanate groups and an alkoxy silane. A water soluble polymer, such as poly(ethylene oxide), can optionally be present. Cross-linking causes a polyurethane or a polyurea network to form, depending upon whether the isocyanate reacts with the hydroxyl donors or the amine donors. U.S. Pat. No. 6,967,261 describes the use of chitosan in wound treatment. Chitosan is a deacetylated product of chitin (C₈H₁₃NO₅)ₙ, an abundant natural glucosamine polysaccharide. In particular, chitin is found in the shells of crustaceans, such as crabs, lobsters and shrimp. The compound is also found in the exoskeletons of marine zooplankton, in the wings of certain insects, such as butterflies and ladybugs, and in the cell wall of yeasts, mushrooms and other fungi. Antimicrobial properties of chitosan have been reported against Gram positive and Gram negative bacteria, including Streptococcus spp., Staphylococcus aureus, Staphylococcus epidermidis, Staphylococcus haemolyticus, Pseudomonas, Escherichia, Proteus, Klebsiella, Serratia, Acinobacter, Enterobacter and Citrobacter spp. Chitosan has also been described in the literature to induce repair of tissue containing regularly arranged collagen bundles.

The composition may also be used to close wounds much like stitches or bandages. To be used in such a way, the composition is applied to at least one skin surface of the opposed skin sections of, for example, a suturable wound of a mammalian patient (e.g., human patient). The opposed skin sections are contacted with each either before or after application of the composition. In either case, after application of the composition, the wound area is maintained under conditions wherein the composition polymerizes to join these skin sections together. In general, a sufficient amount of the composition may be employed to cover the wound and the adjacent the skin surface of at least one of the opposed skin sections of the suturable wound. Upon contact with skin moisture and tissue protein, the composition will polymerize or, in the case of compositions utilizing partially polymerized monomers, will further polymerize, at ambient conditions (skin temperature) over about 10 seconds to 60 seconds to provide a solid polymeric film which joins the skin sections, thereby closing the wound. Generally, the composition can provide a polymeric film over the separated skin sections thereby inhibiting infection of the wound while promoting healing. Further discussion of this use may be found in U.S. Pat. No. 6,214,332.

The coating composition may also be used to cover the nails and mucosal membranes. The microbial indicating dye may be added to various drops, gels, nail polishes and the like to indicate the presence of fungal infections. Nail fungus (onychomycosis) can infect fingernails and toenails and is very common. A common treatment for onychomycosis is to coat the suspect nail with a topical solution of 8% ciclopirox solution, commonly available under the trade name “Penlac”. The indicator may be added, for example, to Penlac® lacquer, (ciclopirox), to indicate the location of nail fungus. The indicator may likewise be added to common nail polish.

The color change inherent in the skin sealant with indicator may be considered as a visual indicator with the user visually observing a color change as a signal that infection or microbial contamination is present, or the color change could also be measured electronically. Such measurements could be conducted using an optical device or other spectroscopic methods known to those skilled in the art to measure changes in color such as spectrophotometers and spectrodenitometers. The instruments measure color space (as described in “Pocket guide to digital printing” (1997) by Frank Cost, Delmar Publishers Inc., at page 144), the most widely used color space is CIELAB. This defines three variables, L*, a*, and b*, that have the following meaning:

L*=lightness, ranging from 0=dark and 100=light.

A*=red/green axis, ranging approximately from −100 to 100. Positive values are reddish and negative values are greenish.

B*=yellow/blue axis, ranging from approximately from −100 to 100. Positive values are yellowish and negative values are blueish.

Because CIELAB color space is somewhat uniform, a single number can be calculated that represents the difference between two colors as perceived by the human being. This difference is termed ΔE and is calculated by taking the square root of the sum of the squares of the three differences (ΔL*, Δa*, and Δb*) between the two colors (i.e. starting color and after color change).

In CIELAB color space, each ΔE unit is roughly a just-noticeable difference between the two colors. A difference of ΔE is clearly visible to a human eye. It is preferred that the microbial indicator herein gives a measurable change in color of ΔE>3.

The composition may be packaged in a “kit” form for use in medical facilities and bundled with the appropriate skin prep solution for ease of use and the convenience of the medical personnel. Kits may also include a container holding the skin sealant composition and another separate container for the pH indicator as previously described. The kit may also include an applicator and means for mixing the contents of the two containers. Alternatively the pH indicator may be impregnated onto a sponge which is used to apply the sealant and through which the skin sealant flows when it is dispensed. In addition, various complimentary or “mating” containers and different packaging schemes have been used for some time and are known in the art.

The following dyes and colorants were demonstrated to undergo a vivid color change when exposed to a co-acid trigger. Each will be described below and the experiments conducted to illustrate the use of these novel dyes and colorants for skin sealant application.

### EXAMPLE 1

100 mg of iron tannate was mixed into 2 gram of n-butyl cyanoacrylate (InteguSeal® skin sealant from Medlogic Global Ltd., Cornwall, UK) to give a deep blue colored liquid. 100 mg of this liquid was placed onto a glass microscope slide (5 cm×7.5 cm) and the liquid drawn into a thin film smear (approximately 3 cm×5 cm) by use of a glass rod. The film was allowed to cure, in approximately 5 minutes, and then a drop (25 mg) of citric acid in tributyl o-acetyl citrate (100 mg citric acid in 2 gram of the citrate) was placed onto the cure film. Within 30 seconds the colored film that was in direct contact with the liquid turned colorless to very pale yellow.

### EXAMPLE 2

100 mg of iron tannate was mixed into 2 gram of n-butyl cyanoacrylate InteguSeal® skin sealant to give a deep blue colored liquid. To this colored liquid was added 20 mg of ascorbic acid powder (USP grade, from Sigma-Aldrich Chem. Co. Inc., Milwaukee Wis.) and the mixture stirred by hand using a glass rod. The deep blue color was discharged within 1-2 minutes of mixing to yield a very pale yellow color.

### EXAMPLE 3

100 mg of iron tannate was mixed into 2 gram of n-butyl cyanoacrylate InteguSeal® skin sealant to give a deep blue colored liquid. To this colored liquid was added 20 mg of citric acid powder (from Sigma-Aldrich) and the mixture stirred by hand using a glass rod. The deep blue color was discharged within 1-2 minutes of mixing to yield a very pale yellow color.

### EXAMPLE 4

100 mg of Rose Bengal (from Sigma-Aldrich) was mixed by hand into 2 gram of InteguSeal® skin sealant to give a red colored mixture. 100 mg of the mixture was then placed onto glass slide and a thin film drawn out by use of a glass rod. The thin film was allowed to cure (approximately 5 minutes) after which time 50 mg of a solution of citric acid in tributyl o-acetylcitrate (50 mg in 1 gram of citrate) was applied to the cured film. In less than 10 seconds the film that was in direct contact with the citric acid solution was colorless. Thus the red color was discharged to give a clear, transparent colorless film.

### EXAMPLE 5

100 mg of Rose Bengal was mixed by hand into 2 gram of InteguSeal® skin sealant to give a red colored mixture. To this mixture was added 20 mg of ascorbic acid (USP grade) and mixed. The red color of the mixture was discharged to a colorless liquid within 1-2 minutes.

### EXAMPLE 6

100 mg 1-amino-4-hydroxyanthraquinone (from Sigma-Aldrich) was mixed into 2 gram of InteguSeal® skin sealant to give a cherry red colored liquid. To this mixture was added 30 mg of citric acid and mixed by hand. Within 1-2 minutes the color had changed to a purple color.

### EXAMPLE 7

100 mg of Disperse Blue 3 (from Sigma-Aldrich) was mixed into 2 gram of skin sealant to give a blue colored solution. To this mixture was added 50 mg of citric acid and mixed by hand. Within 2 minutes the color had changed to red.

### EXAMPLE 8

100 mg of 1,4-diaminoanthraquinone (from Sigma-Aldrich) and 2 gram of InteguSeal® skin sealant were mixed together to give a violet colored liquid. To this mixture was added 50 mg citric acid and stirred by hand. Within 2 minutes the color had completely changed to a pale pink in color.

### EXAMPLE 9

100 mg of trans-β-carotene (Food Orange 5, from Sigma-Aldrich) and 2 gram of InteguSeal® skin sealant were mixed together to give a bright red colored liquid. To this mixture was added 50 mg citric acid and stirred by hand. Within 2 minutes the color had completely changed to a colorless and transparent film.

### EXAMPLE 10

100 mg of trans-β-carotene and 2 gram of InteguSeal® skin sealant were mixed together to give a bright red colored liquid. To this mixture was added ascorbic acid USP (Sigma-Aldrich) and stirred by hand. Within 2 minutes the color had completely changed to a colorless and transparent film.

### EXAMPLE 11

An onion glass vial containing 2 gram of InteguSeal® and 200 ppm trans-β-carotene was placed inside the InteguSeal® applicator device. Earlier the foam component of the applicator had been separated from the device and soaked in an ethanol solution of ascorbic acid (0.9 gram ascorbic acid in 10 ml of ethanol). The foam was then air-dried in a fume-hood. The applicator was re-assembled with the vials inside the applicator and the foam on the outside at the exit port for the sealant. The applicator was activated in the usual manner by pushing the handle inwards to smash the vial. The sealant was then allowed to exit the applicator through the foam, in the usual manner, and applied to a glass plate (12 cm×12 cm). The skin sealant was red when applied to the glass plate but after 2 minutes the red color was discharged to leave a colorless transparent film. The red skin sealant dissolved and mixed with the ascorbic acid as it difused through the foam. This triggered the color to be discharged. The timing of the reaction allowed the user to see where the sealant had been applied to the glass sheet and also any missed spots/areas before the color was discharged by the action of the ascorbic acid.

As will be appreciated by those skilled in the art, changes and variations to the invention are considered to be within the ability of those skilled in the art. Such changes and variations are intended by the inventors to be within the scope of the invention. It is also to be understood that the scope of the present invention is not to be interpreted as limited to the specific embodiments disclosed herein, but only in accordance with the appended claims when read in light of the foregoing disclosure.

What is claimed is:

1. A curable coating comprising a mutable color changing composition.

2. The coating of claim 1 wherein said composition comprises a pH indicator, acid and skin sealant.

3. The coating of claim 2 wherein said sealant is a cyanoacrylate, polysaccharide, silicone, polyvinylpyrolidone, gelatin, polysiloxane-polyether or a mixture thereof.

4. The coating of claim 1 wherein said mutability is triggered by acid.

5. The coating of claim 4 wherein said acid is an organic acid selected from citric, ascorbic, malic, acetic, propanoic, malonic and cysteine.

6. The coating of claim 2 wherein said pH indicator is an organic dye or a metal salt colorant.

7. The coating of claim 6 wherein said pH indicator is a metal tannate salt

8. The coating of claim 2 wherein said pH indicator is selected from anionic xanthene dyes, carotenoid dyes quinone dyes.

9. The coating of claim 8 wherein said pH indicator is selected from rose bengal, trans-β-carotene, disperse blue 3,1-amino-4-hydroxyanthraquinone, or iron tannate.

10. The coating of claim 1 wherein said color change occurs after mixing said indicator, acid and sealant within 10 minutes.

11. The coating of claim 1 wherein said color change occurs after mixing said indicator, acid and sealant within 5 minutes.

12. The coating of claim 1 wherein said color change occurs after mixing said indicator, acid and sealant within 3 minutes.

13. The coating of claim 2 wherein said pH indicator is present in an amount between about 0.09 and 1.5 weight percent of the sealant.

14. A curable coating comprising a triggerable pH indicator, an acid trigger and a skin sealant.

15. The coating of claim 14 wherein said pH indicator is impregnated onto a foam which is used to apply said sealant.

16. The coating of claim 14 wherein said pH indicator is applied separately from said skin sealant from a separate reservoir.

17. The coating of claim 14 wherein said pH indicator is applied simultaneously with said skin sealant but from a separate reservoir.

18. The coating of claim 14 used to cover wounds, bruises, abrasions, burns, acne, blisters, bites, stings, punctures, splinters, cuts and other disruptions in the skin to protect them from subsequent contamination.

19. The coating of claim 14 used to close wounds.

20. The coating of claim 14 is packaged in a “kit” form.
